(19) United States
(12) Patent Application Publication
(10) Pub. No.: US 2014/0200969 A1
(43) Pub. Date: Jul. 17, 2014

(54) RATING ITEMS

(71) Applicant: HEWLETT-PACKARD DEVELOPMENT COMPANY, L.P., Houston, TX (US)

(72) Inventors: Michael J. Brzozowski, Mountain View, CA (US); W. Alex Vorbau, Los Altos, CA (US); Bernardo Huberman, Palo Alto, CA (US)

(21) Appl. No.: 14/122,161

(22) PCT Filed: Jun. 3, 2011
(86) PCT No.: PCT/US11/39037

§ 371 Date: Mar. 17, 2014

(51) Int. Cl. G07C 13/00

(52) U.S. Cl. CPC G07C 13/00
USPC 705/12

(57) ABSTRACT

In one example, a process may include using a computer (110) to select a pair of items (150A, 150B) from among a set of items (150); presenting the selected pair of items (150A, 1506) to a voter (130); requesting that the voter (130) choose one of the items (150A or 1506) from the pair; receiving an answer (180) from the voter (130); and using the computer (110) to update respective ratings (170) of the items (150A, 1506) in the pair. Changes in the ratings (170) depend on the answer (180) and on a difference between the ratings of the items (150A, 1506) in the pair.

### BACKGROUND

Businesses, organizations, and individuals often evaluate items to determine which are best or most liked by a target audience. Evaluated items can be almost anything including, for example, services, products, product features, artistic creations, and ideas and may be evaluated under a number of criteria such as utility, appearance, and value. Businesses often use the results of evaluations when making decisions such as which products or features a business will develop. Individuals may also use evaluation processes that provide the judgments, preferences, or opinions of others.

### BRIEF DESCRIPTION OF THE DRAWINGS

FIG. 1A shows a system in accordance with an example implementation.

FIG. 1B represents data structures that may be maintained by a service in accordance with an example implementation.

FIG. 2 is a flow diagram of an evaluation process in accordance with an example implementation.

FIG. 3 is a flow diagram of a vote and rating process n accordance with an example implementation.

FIG. 4 is a flow diagram of a process in accordance with an example implementation in which a user may change a list of items being evaluated after an evaluation process has begun.

FIG. 5 is a flow diagram of a process for reporting evaluation results or providing a payout to winning voters in accordance with an example implementation.

Use of the same reference symbols in different figures indicates similar or identical items.

### DETAILED DESCRIPTION

The evaluation of a large number of items can be a time consuming process. For a business, a single person or a panel responsible for reviewing and evaluating potential projects can become a bottleneck in the decision making process, particularly when a large number of candidate projects must be considered and compared. To reduce the burden on individual reviewers and improve throughput, some evaluation processes invite large populations to help pick the best items. Crowdsourcing is a practice that uses open calls to a large and often unidentified group, i.e., a crowd, to perform a task, and some Internet services employ crowdsourcing for evaluation purposes. For example, an Internet service such as Google Moderator may allow people to vote “up” or “down” on prospective ideas and count the votes to determine a winner from among the ideas. However, such evaluation processes may not provide reliable results because many people that vote will not have or take the time necessary for thoughtful consideration, particularly if a large number of items are involved. As a result, votes tend to be biased toward the well known items, rather than items that are best under the relevant criterion. Further, many evaluation processes allow a voter to endorse every item, for example, with an “up” or “like” vote without specifically indicating a ranking or preference among items. Voters that “like” all or most options effectively create signal noise and can make reliable identification of the best items more difficult.

Another concern for evaluation processes is that the list of candidate items to be evaluated may change. For example, developers of a product or service often face a continuous stream (or deluge) of feature requests. In response, some developers have adopted “agile methodology,” which requires frequent prioritization of open issues. Static polls may not be well suited for evaluation of a list of items that is constantly evolving because older items may have already accumulated votes before the newer items were added.

In one implementation, a crowdsourcing process using pair-wise comparisons can handle evaluation of any number of items without increasing the complexity of individual votes and can employ a large number of voters to manage the burden on individual voters. For example, an evaluation process can be broken up into a collection of simple pair-wise comparisons, and for each pair-wise comparison, a voter is presented with a pair of items A and B sampled from a list of items. For each vote, the voter simply specifies whether the voter prefers item. A or B. Each vote is thus a simple and brief task that each voter can perform many times and that can be parceled out to many people. The evaluation process can be offered as a service for a fee to users having items to evaluate and may be presented to a large number of voters through an Internet web site or other convenient communication channels.

In another implementation, each item being evaluated has a rating, and each vote indicating a choice of the better item from a pair of items results in changes of the ratings of the two compared items by an amount or amounts that depend on the difference between the ratings of the items in the pair. As used herein, a rating for an item refers to a numerical score, which may be representative of the value of the item in terms of the selected criteria for evaluation. Each vote can thus be treated as a contest between items with the results of the contest increasing the rating of the winning item and decreasing the rating of the losing item in a manner similar to the system employed for rating chess players. The ratings of the items at the end of an evaluation process containing a statistically desired number of votes can be used to rank the items from best to worst. For example, a list of items may be ordered according to rating with the items having the highest ratings receiving the best ranks.

In another implementation, an evaluation process can be presented to voters as a game that provides the voters with an incentive to make well-reasoned votes. For example, voters may be required to pay a fee in order to take part in an evaluation game. To play the game, each voter submits a number of votes. The votes may be conducted as described above, where for each vote, the voter is presented a pair of items and chooses an item from the pair. At the end of the game, the voter or voters that make the most “correct” votes, i.e., votes that are consistent with the final results of the evaluation process, are rewarded from a prize pool that may include the voters' fees, the user's fees, or other prizes. The service providing the game may take all or a portion of the user's or voters' fees. In such a game, voters that pay fees or could win a prize are likely to take voting seriously, and each voter has an incentive to make votes that are most likely to be correct. The results of the evaluation game can be useful to a user that wanted the items ranked or items may be presented simply for game purposes, e.g., to provide items and comparisons that may be of interest to the voters.

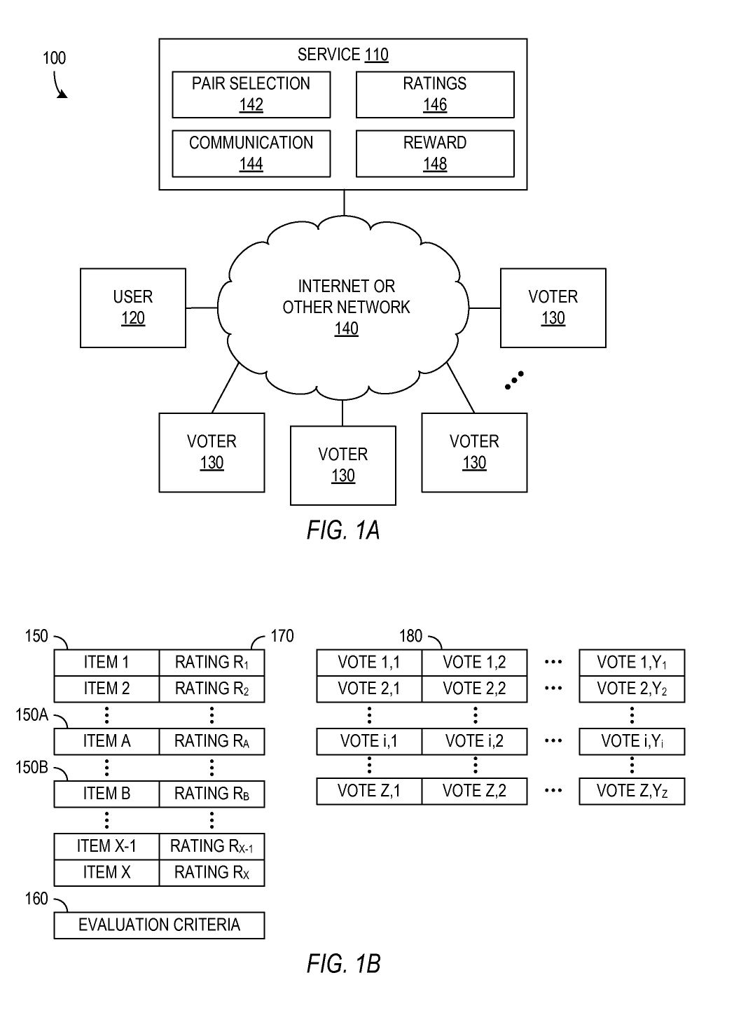

FIG. 1A illustrates an implementation of a computing system 100 that may be used for the evaluation of items. System 100 includes a service device 110, a user device 120, and a collection of voter devices 130 that communicate over a network 140. Each device 110, 120, 130 can be a computer with appropriate software (e.g., executable instructions stored in non-transitory computer-readable media) to perform processes such as described in more detail below. The term computer is used here in a broad sense to include a variety of computing devices such as desktop computers, laptop computers, tablets, game consoles, electronic books, smart phones, other devices having processors or other structures capable of implementing the processes described herein, and combinations of such computing devices that collectively perform the processes described herein.

In an exemplary implementation, service device 110 is a server system connected to a wide area network such as the Internet. User device 120 may be a desktop computer employing a browser to communicate with service device 110, and voter devices 130 may be a mixture of different types of devices such as desktop computers, portable computers, tablets, and smart phones similarly employing browsers to communicate with service device 110. As will be understood by those of skill in the art, the configuration of devices illustrated in FIG. 1A can be altered in a variety of ways without departing from principles described herein. For example, service device 110 might also be employed to perform the functions of user device 120 or one or more of voter devices 130. In one implementation, a single computer acts as all of service device 110, user device 120, and voter devices 130, so that network 140 may not be necessary. Also, network 140 may be a public or a private network of any type. For example, network 140 can be a private local area network or a network providing secure connections for a situation in which the items being evaluated are to be kept confidential among the service, user, and voters. A private or local network may also be used in implementations where a game is being confined to a specific location, for example, because of legal restrictions.

The illustrated implementation of service device 110 in FIG. 1A includes modules 142, 144, 146, and 148 that are employed to manipulate the data structures shown in FIG. 1B. In particular, pair selection module 142 operates to sample from a list of items 150 to select pairs of items for pair-wise comparisons at voter devices 130. Communication module 144 communicates with user device 120 to receive items 150 and evaluation criteria 160 and communicates with voter devices 130 to present selected pairs for comparisons and to receive votes or answers 180. Ratings module 146 uses answers 180 from voters to generate respective ratings 170 for items 150. Reward module 148 uses the ratings to determine results from the evaluation process and issue rewards to winning voters. Examples of processes that may be implemented using modules 142, 144, 146, and 148 are described further below.

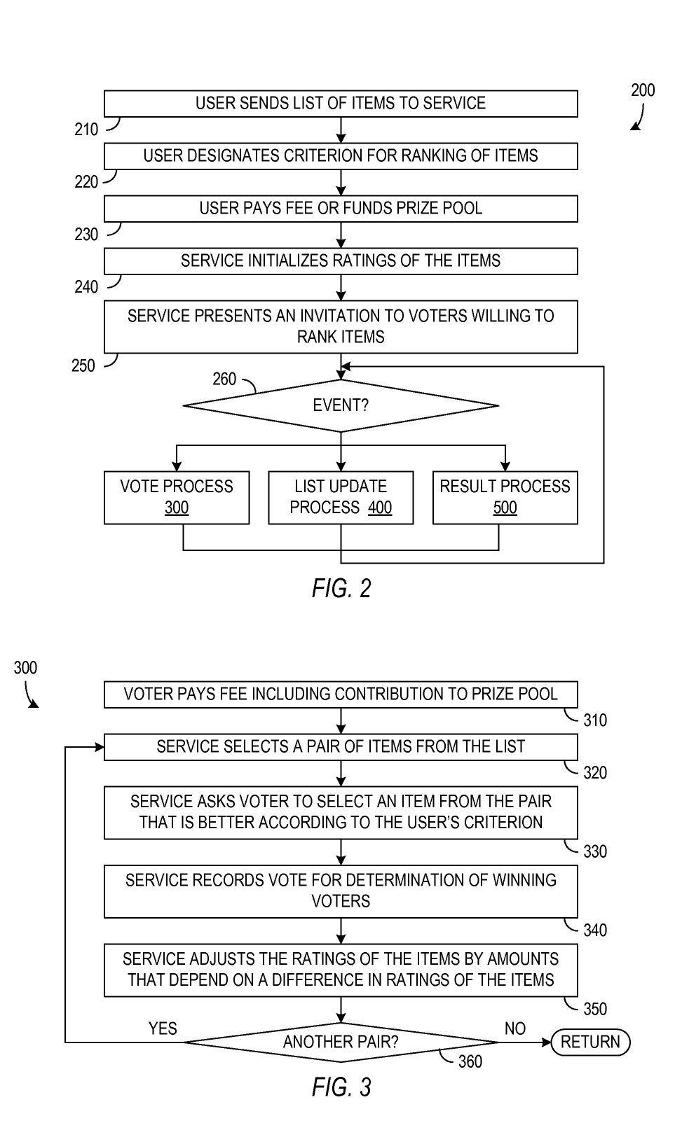

FIG. 2 is a flow diagram of an evaluation process 200 that may be implemented in system 100 of FIG. 1A using the date structures of FIG. 1B. In an initial step 210, a user interested in crowdsourcing a ranking or selection of the best item or items among a collection of items begins by creating a list of the items, and user device 120 sends the list of items to a service operating service device 110. Service device 110 stores the received items 150. Items 150 may, for example, be text descriptions (e.g., of business ideas, slogans, or feature requests) or media files (e.g., music, sound clips, images, or videos). The user in step 220 may also provide criteria 160 for evaluation of the items 150. Criteria 160 may indicate a question to be asked of voters. For example, the user may be interested in knowing: “Which of the listed products are voters most likely to buy?”; “Which program features do voters need most?; or “Which of the listed sandwich materials looks best on a slice of bread.” Criteria 160 may also designate demographics or qualifications of the voters to evaluate the items.

The service may charge a fee for conducting the evaluation process, which the user pays in step 230. Additionally, the user in step 250 may help to fund a prize pool that may be given to one or more winning voters as described further below.

The service in step 240 initializes ratings 170 of the items in the list. For example, all items can be initialized to the same score, e.g., all items assigned an initial rating of 0, which may be appropriate if there is no reason to believe that any item is preferred over the other items. Alternatively, items can be assigned ratings 170 according to user preferences, according to additional information such as may have been obtained in a prior evaluation process, assigned according to any given rule, or assigned arbitrarily. The service in step 250 then invites voters to participate in the evaluation process. For example, the service can send a link to a list of people, asking them to view the list of items, e.g., photos or business ideas. The service then waits in step 260 for an event. The list of people allowed to vote may be restricted by criteria 160.

The service begins a vote process 300 each time a voter clicks the invitation link or otherwise indicates to the service a willingness to participate. FIG. 3 is a flow diagram of an exemplary implementation of vote process 300. In the illustrated implementation of FIG. 3, a voter in step 310 may be required to pay a fee. In particular, a fee may be required in implementations in which the evaluation process is presented to voters as a game, and the vote process ends if the voter does not pay the fee. Some other implementations of process 300 do not request fees from the voters, and step 310 is skipped.

The service in step 320 presents the voter with a pair of items sampled from the user's list and presents a question based on the user's criteria for the evaluation process. For example, the service may present two images or photos to a voter along with the question “Which photo would look better in a desk frame?” The voter is also presented with potential answers, which will at least allow the voter to select one of the two items, e.g., A or B. The user may also be presented with other options such as “A and B are equal” or “I can't decide.” After the voter chooses and returns an answer, the service can perform steps that are unseen by the voter such as a step 340 of recording the vote for later determination of game winners and a step 350 of adjusting the ratings of the two items just compared.

The service, in step 360, determines whether to present another pair of items to the voter. For example, in one implementation, the voter's fee paid in step 310 may cover a set number of votes, and another pair of items is presented to the voter if the voter has not used up the purchased number of votes. In another implementation, the voter can choose whether to continue voting as many times as the voter wants, and another pair of items is presented to the voter. Whenever the voter is presented with another vote, process 300 branches from step 360 to repeat steps 320 and 330 to reload the page with another pair of items, and the voter can continue voting on pairs.

The pair of items presented to a voter for any pair-wise comparison can be selected randomly or systematically from among the list. In one implementation, the selection of pairings in repetitions of step 320 can depend on the ratings of the items. For example, with the goal of achieving more accuracy for the ratings of the best items, step 320 may be made more likely to select items with higher ratings for the comparison. In one specific implementation, a number W of items having the highest ratings are identified, for example, by voting that verifies that the W highest rated items defeat all the candidates below a rating threshold and then pairings are selected to preferentially include both items from the W highest rated items. In another implementation, items having similar ratings are preferentially paired to better distinguish which of the items may be better. In yet another implementation, items previously presented in fewer comparisons are preferentially selected for subsequent comparisons, so that each item is involved in a statistically sufficient number of comparisons.

Recording of a vote as in step 340 may only be needed if the service needs to identify winning voters for rewards. FIG. 1B illustrates an example in which each voter i cast Yᵢ votes that the service records. The numbers Y₁ to Y_{Z} respectively from voters 1 to Z may be different or the same. In general, the total number of votes needed to achieve results with a desired statistical accuracy will depend on the number X of items being rated.

Step 350, which changes the ratings of items based on a vote, can employ a rating system that changes the rating of the two items involved in the vote by an amount or amounts that depend on the difference in the ratings of the two items. By convention, a rating system is commonly such that a higher rating is better, and the rating of an item increases when the item “wins” in a pair-wise comparison or decreases whenever the item “loses” in a pair-wise comparison. Alternatively, the opposite convention could be used. In which case, lower ratings are better, and an item's rating decreases after winning a comparison or increases after losing a comparison. Without loss of generality, the following description assumes that higher ratings are better. The magnitude of the change in an item's rating depends on the difference between the rating of the item and the rating of the other item in the comparison. Winning against an item with a higher rating results in a larger increase than winning against a lower rated item.

Comparisons of a pair of items A and B in some implementations of step 330 may give a voter choices other than “A is better” or “B is better.” For example, a voter may be able to select “A and B are equal” or “I can't decide.” The rating system used in step 350 can also take into account a vote other than A or B. For example, a vote indicating that A and B are equal can be considered a draw in the rating system, and the ratings of A and B may be changed by amounts that depend on the difference between the ratings of A and B. The change for a “draw” may be less, e.g., one half of, the change for a win or a loss. Alternatively, a vote such as “I don't know” or “I can't decide” could be ignored for ratings purposes.

The votes can be employed in a rating system that in one specific implementation of step 350 is similar to the rating system that is used for calculating the relative skill levels of players in two-player games such as chess. In particular, after a pair-wise comparison with an item B having a rating R_{B}, an item A with a rating R_{A} is assigned a new rating R_{A}′ as given in Equation 1 in which: W is a performance value 1, 0.5, or 0 depending on whether A won, drew, or lost the comparison; and E indicates an estimated performance of item A relative to item B based on their current ratings R_{A} and R_{B}. Factor K can be a constant that is selected according to the desired average magnitude or separation of the ratings or based on the number of votes expected. Factor K could alternatively be a function, for example, that decreases with the number of comparisons. Equation 2 indicates an estimated performance E of a higher ranked item A against a lower ranked item B in one implementation of a rating system in which wins and losses respectively count as 1 and 0 and draws (when possible) count as 0.5. For this specific rating system, the performance of item B in the comparison with item A is (1−W), and the estimated performance for item B is (1−E). As a result, the change in the rating R_{B} is the negative of the change in rating R_{A} as shown in Equation 3. This characteristic of the rating system maintains the average rating of the items.

$$\begin{matrix}{R}_{A}^{′} = {A}_{A} + K ( W - E ) & Equation 1 \\ E = \frac{1}{1 + exp ( {R}_{B} - {R}_{A} )} & Equation 2 \\ {R}_{B}^{′} = {R}_{B} + K ( ( 1 - W ) - ( 1 - E ) ) = {R}_{B} - K ( W - E ) & Equation 3\end{matrix}$$

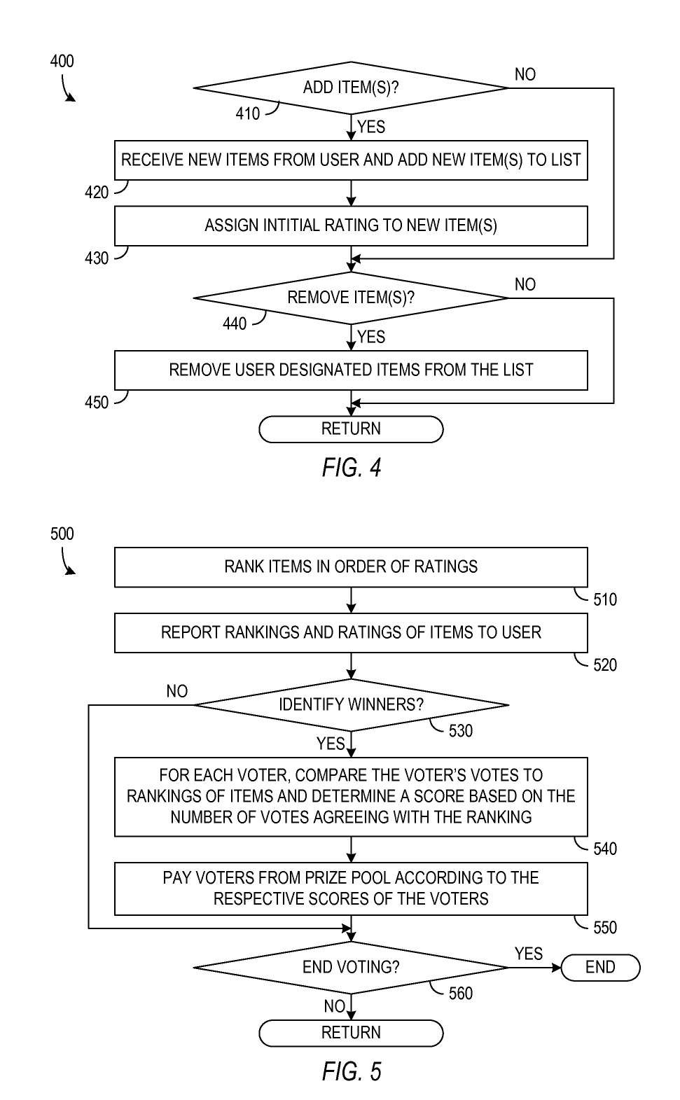

An advantage of the rating system described above is that it may permit the user to change the list of items during the evaluation process. For example, in process 200 of FIG. 2, one event that may occur in step 260 is a user requesting an update of the item list. The service responds to this list by performing a list update process 400. FIG. 4 shows a flow diagram of one implementation of list update process 400. In the implementation of process 400 shown in FIG. 4, the service determines in step 410 whether the user is seeking to add an item to the list. If so, the service receives the new item or items from the user, e.g., receives text descriptions or media, in step 420 and assigns the new items an initial rating or ratings in step 430. The ratings can be assigned using the same techniques described for step 240 of FIG. 2. It is not critical that the initial rating for the new item be an accurate rating for the item because an underrated item will quickly gain rating points from winning comparisons with higher rated items and an overrated item will quickly lose rating points from losing comparisons with lower rated items. However, the added item may be assigned the average rating of all the items if it is desired that the average rating be preserved.

Step 450 determines whether the user is seeking to remove items from the list. If so, the service can simply remove the item in step 450. The prior comparisons involving removed items are still valid for ratings of the other items, so that no ratings need to be changed when the items are removed.

Results from the evaluation process can be returned to the user at the end of the process or at any time during the evaluation process. Ranking the items can simply be performed by ordering the items based on the ratings, e.g., with higher rated items receiving higher ranks. In the process of FIG. 2, step 260 upon detecting a reporting event can execute a result process 500, for example. to provide the user with the results of the evaluation.

Some implementations can use an incentive mechanism to induce voters to volunteer their pair-wise comparisons of whatever set of items or ideas are presented to them, and ideally convey a truthful opinion of what the voters think is best. One incentive mechanism rewards whoever ranks highest the item that the consensus of other voters also considers to be the best. Another incentive mechanism rewards whoever provides the most votes or the highest percentage of votes that are consistent with the final results of the evaluation process.

FIG. 5 is a flow diagram of a results process 500 that includes an incentive mechanism that rewards voters for voting and for making reasoned votes. The illustrated implementation of process 500 begins with a step 510 of ranking the items according to their respective ratings when the result process 500 begins. The rankings can then be reported to the user in step 520. In an alternative implementation of process 500, the evaluation process is not requested by a user but is provided to the voters as a game, so that the step 520 of reporting the results is unnecessary.

Step 530 determines whether winners of the evaluation process should be identified for payment. Identifying winners is primarily for evaluation processes in implementations that reward the voters, and identifying winners may only occur if additional conditions are met such as the evaluation game being complete. When winners are identified, step 540 compares the votes (e.g., votes 180 of FIG. 1B) of the individual voters to the results of the evaluation. For example, a vote may be considered to be “correct” if the vote selected the higher rated or ranked item over the lower rated or ranked item. The correct and incorrect votes of a voter can then be used to determine a score for the voter, One technique might score each voter according to the number or percentage of correct votes, but other rules for scoring votes could be employed to reward a voter for providing well reasoned votes. Step 550 could then pay the winning or highest scoring voter or voters from the prize pool. For example, the voter with the best score may win the entire prize pool. Alternatively, some or all voters may receive prizes depending on their respective scores. In one implementation, the prize pool includes at least a portion of fees paid by the voters. In another implementation, the user may fund the prize pool to provide an incentive for reasoned voting.

Voters participating in an evaluation including result process 500 of FIG. 5 may be encouraged not only to vote based on what they think is best but also to vote based on what they think others will think is best because winnings will depend on the results based on the preference of all voters. The introduction of a cost to play and/or a reward discourages “cheap talk” in an evaluation and encourages the voters to think carefully about their votes. The prize pool could include a monetary award or a prize other than a monetary award. For example, voters could also be incented to do comparisons in exchange for having others evaluate their own items, so that a voter for one evaluation process may be the user for another evaluation process. Further, different types of rewards could be combined and employed in combination in a social networking environment. For example, participants in a social networking environment could vote on friends' content just to be helpful, vote on strangers' content to earn credits for getting their own content evaluated, or pay to have other participants evaluate their content.

Various implementations of systems and methods described above may achieve several key advantages. For example, an implementation using pair-wise comparison can select pairs of items to focus voters' contributions on determining which items belong among the top ranks without wasting voter energy on determining an exact ordering of the least-preferred candidates. An evaluation process in accordance with an implementation using ratings may be able to elucidate a rank ordering of candidates more efficiently than absolute rating schemes (e.g., thumbs up/down or star ratings), which some studies have indicated cannot be guaranteed to deliver an accurate rank ordering. Some implementations of evaluation processes using ratings may also allow candidate items to be added to a poll at any time without penalizing the added items, which enables use of such evaluation processes for open-ended innovation campaigns and scrum development processes. Some implementations can encourage reasoned voting and better results through providing incentives. More generally different implementations can contain different combinations and variations of the features to achieve different combinations of such advantages.

The above description concentrates on some specific implementations of example systems or processes. However, additional systems employing the above-described principles can be implemented as computer readable media containing instructions that are executable by one or more processors to perform one or more of the processes described herein. Such computer readable media includes non-transitory media such as hard drives, computer readable disks, flash drives, and other storage devices.

Although particular implementations of systems and processes have been described above, the description only provides some illustrative examples that should not be taken as limitations.

What is claimed is:

1. A process comprising:
using a computer (110) to select a pair of items (150A, 150B) from among a plurality of items (150);
presenting the selected pair of items (150A, 1506) to a voter (130);
requesting that the voter (130) choose one of the items (150A or 150B) from the pair; and
receiving an answer (180) from the voter (130);
using the computer (110) to determine a difference between the ratings of the items (150A, 150B) in the pair and to update the ratings (170) in a manner that depends on the answer (180) and the difference in the ratings (170).

2. The process of claim 1, wherein in selecting the pair of items (150A, 150B), the computer (110) selects the items (150A, 150B) using a process that has different probabilities for selecting different items (150), and for each of the items (150), the probably that the item will be selected depends on the rating (170) of the item (150).

3. The process of claim 2, wherein the process used in selecting the pair of items (150A, 150B) has a higher probability of selecting the items (150) having a higher rating.

4. The process of claim 2, wherein the process used in selecting the pair of items (150A, 150B) has a higher probability of selecting a pair of the items (150) having a smaller difference in the ratings of the items in the pair.

5. The process of claim 1, wherein requesting that the voter (130) choose one of the items (150A, 150B) includes indicating criteria (160) for distinguishing the items (150A, 150B).

6. The process of claim 5, wherein the answer (180) from the water (130) has possible values including that the items (150A, 150B) are equal based on the criteria (160).

7. The process of claim 1, further comprising repeating the steps of claim 1 a plurality of times to receive a plurality of answers and update the ratings of the items a plurality of times.

8. The process of claim 7, further comprising:
changing the list after receiving the plurality of answers;
assigning initial ratings to any of the items that were added to the list when the list was changed; and
repeating the steps of claim 1 a plurality of times to update the ratings of the items in the list including the items in the list before and after the adding.

9. The process of claim 8, wherein updating the ratings of the items uses the ratings of any of the items that were in the list before and after the changing of the list.

10. The process of claim 1, further comprising repeating the steps of claim 1 a plurality of times respectively for a plurality of voters (130).

11. The process of claim 10, wherein repeating the steps continues until the answers (180) from the voters (130) provide the ratings with values that indicate a ranking of the plurality of items (150).

12. The process of claim 11, further comprising assigning the ranking of the items (150) in an order from highest rating to lowest rating.

13. A non-transitory computer readable media containing instructions that are executable by a computer to perform a process comprising:
selecting a pair of items (150A, 150B) from among a plurality of items (150);
presenting the selected pair of items (150A, 150B) to a voter (130);
requesting that the voter (130) choose one of the items (150A or 150B) from the pair; and
receiving an answer (180) from the voter (130);
determine a difference between the ratings of the items (150A, 150B) in the pair; and
updating the ratings (170) in a manner that depends on the answer (180) and the difference in the ratings (170).

14. A system comprising:
a first computer (110) including:
a selection module adapted to select a pair of items (150A, 150B) from among a plurality of items (150);
a communication module operable to communicate the selected pair of items (150A, 150B) to a voter (130), request that the voter (130) choose one of the items (150A or 150B) from the pair; and receive an answer (180) from the voter (130); and
a rating module operable to update respective ratings (170) of the items (150A, 150B) in the pair, wherein changes in the ratings (170) depend on the answer (180) and a difference between the ratings (170) of the items (150A, 150B) in the pair.

15. The system of claim 14, further comprising a second computer (130) adapted to present to a voter with pairs of items (150) received from the first computer (110) and to communicate answers (180) from the voter back to the first computer (110).
